(19) United States
(12) Patent Application Publication
(10) Pub. No.: US 2023/0077229 A1
(43) Pub. Date: Mar. 9, 2023

(54) AUXILIARY SERVICE PANEL ON HIGH VOLTAGE DISTRIBUTION BOX

(71) Applicant: RIVIAN IP HOLDINGS, LLC, Irvine, CA (US)

(72) Inventors: Kyle O'Neil, Los Angeles, CA (US); Luke Rayment Morrow, Gilroy, CA (US)

(21) Appl. No.: 17/855,505

(22) Filed: Jun. 30, 2022

Related U.S. Application Data
(60) Provisional application No. 63/240,760, filed on Sep. 3, 2021.

(51) Int. Cl. H01M 50/271; H01M 10/44; H01M 10/48; H01M 10/42; H01M 50/204; H01M 50/296; H01M 50/249; H02J 7/00

(52) U.S. Cl. CPC H01M 50/271; H01M 10/44; H01M 10/48; H01M 10/425; H01M 50/204; H01M 50/296; H01M 50/249; H02J 7/0063; H02J 7/0047; H01M 2010/4271; H01M 2220/20

(57) ABSTRACT

A battery pack assembly is provided having auxiliary service panels on its lid to provide access to interior battery pack components without having to remove the lid. The auxiliary service panels each cover respective openings above regions of a battery pack housing, which may be separated by a battery module. Once the panels are removed, external devices can access interior battery pack components to discharge battery cells and monitor the battery pack components while discharging.

### CROSS-REFERENCE TO RELATED APPLICATIONS

This application claims priority to U.S. Provisional Patent App. No. 63/240,760, filed on Sep. 3, 2021, the entire contents of which are hereby expressly incorporated by reference in their entirety.

### INTRODUCTION

The present disclosure relates to a battery pack that allows for access to the battery pack's components. More particularly, the present disclosure relates to access to discharge the battery pack.

### SUMMARY

Vehicle battery packs are susceptible to many environmental stressors that may inhibit their operation. Due to their location beneath electric vehicles, if the vehicle drives on an especially hot day, for example, thermal stressors may cause a hardware malfunction within the battery pack. To service the pack, the battery pack typically must be discharged (e.g., below a threshold charge) to safely troubleshoot the issue and determine what's wrong. Accordingly, the entire cover of the battery pack must be removed, which requires removing a myriad of welds and/or bolts fastened to the pack assembly, to access its components and discharge the battery pack. This is a labor and time intensive service procedure.

Systems and methods are descried herein for a battery pack assembly with a lid including auxiliary service panels over one or more high voltage distribution boxes (HVDBs) (e.g., of a battery pack assembly). Although figures disclosed herein depict example diagrams of the battery pack assembly with a first and a second auxiliary service panel, the battery pack assembly may include any suitable number of auxiliary service panels. The first auxiliary service panel is positioned to provide access to an unswitched terminal of a first polarity (e.g., positive) on the left side of the battery pack assembly, and the second auxiliary service panel is positioned to provide access to an unswitched terminal of a second polarity (e.g., negative) on the right side of the battery pack assembly. In some embodiments, however, the locations of polarity may be switched so that the first polarity (e.g., positive) is on the right side of the battery pack and the second polarity (e.g., negative) is on the left side of the battery pack. The battery pack assembly may include a plurality of crossmembers that form a plurality of bays in the battery pack meant to house battery cells. In some embodiments, the auxiliary service panels are positioned above a front bay of the plurality of bays, although the orientation of the battery pack assembly may include any suitable orientation. For example, the battery pack assembly may include a side bay or a bottom bay in addition to the front bay where the auxiliary service panels may be located above. In some embodiments, a battery module positioned in the battery pack housing separates the location of the first auxiliary service panel and the second auxiliary service panel by a distance greater than the length of the battery module.

In order to discharge the battery cells of the battery pack assembly, the first and the second auxiliary service panels provide access to battery components a device (e.g., a robotic arm) can work with to discharge the battery cells and monitor electrical signals within the battery pack. In some embodiments, the first auxiliary service panel provides access to a port of the battery management system (BMS), which allows for isolated SPI communication protocol to receive live voltage, current, and temperature signals from the battery pack assembly. In some embodiments, the battery management system may be affected by the external stressor causing the battery pack assembly to malfunction, which would require the coupling of an external monitoring device to a data connector of the battery pack assembly to monitor voltage, current, and temperature signals from the battery pack assembly via the isolated SPI communication protocol. In some embodiments, the first auxiliary service panel provides access to a first flap blade connector and the second auxiliary service panel provides access to a second flap blade connector. This access enables coupling of a first lead of an external device to the first flap blade connector and a second lead of the external device to the second flap blade connector to concurrently discharge the battery cells of the battery pack assembly while monitoring electrical signals with the external monitoring device.

The first auxiliary service panel and the second auxiliary service panel are each releasably attached to a first opening and a second opening, respectively, with one or more bolts. In some embodiments, the one or more bolts may include a bolt that fastens to the lid of the battery pack in addition to the access service panel. In some embodiments, the battery pack assembly includes a first sealing gasket positioned between the first auxiliary service panel and the lid surrounding the first opening and a second sealing gasket positioned between the second auxiliary service panel and the lid surrounding the second opening.

### BRIEF DESCRIPTION OF THE DRAWINGS

The above and other objects and advantages of the disclosure will be apparent upon consideration of the following detailed description, taken in conjunction with the accompanying drawings, in which;

FIG. 1 shows an isometric exploded view of an exemplary battery pack assembly, in accordance with some embodiments of the present disclosure;

FIG. 2A shows an additional depiction of an exemplary battery pack assembly, in accordance with some embodiments of the present disclosure;

FIG. 2B shows a perspective view of a battery pack assembly including a lid with auxiliary service panels, in accordance with some embodiments of the present disclosure;

FIG. 3 shows an external monitoring device and a closeup view of a first opening in the battery pack assembly lid displaying various battery pack components, in accordance with some embodiments of the present disclosure;

FIG. 4A shows an external device and a closeup view of battery pack assembly components on a first side, in accordance with some embodiments of the present disclosure;

FIG. 4B shows a closeup view of battery pack assembly components on a second side, in accordance with some embodiments of the present disclosure;

FIG. 5A shows a closeup view of an auxiliary service panel, in accordance with some embodiments of the present disclosure;

FIG. 5B shows a bottom view of an auxiliary service panel, in accordance with some embodiments of the present disclosure;

FIG. 6A shows a closeup view of an alternative design of battery pack assembly components, in accordance with some embodiments of the present disclosure; and

FIG. 6B shows a closeup view of an alternative design of battery pack assembly components, in accordance with some embodiments of the present disclosure.

### DETAILED DESCRIPTION

In one embodiment, the present disclosure relates to a battery pack assembly for an electric vehicle with a lid including auxiliary service panels, which offers immediate access to the battery pack components to address internal issues by discharging a plurality of battery cells and monitoring electrical signals (e.g., voltage, current, temperature, etc.) sent by battery pack components while discharging. An external device (e.g., a battery discharger) couples to a first flap blade connector via a first opening and a second flap blade connector via a second opening to discharge the battery cells while an external monitoring device concurrently couples to a data connector via the first opening to monitor electrical signals received from the battery pack components.

As referred to herein, a “battery pack assembly” is an enclosure including at least one auxiliary service panel, one or more battery modules, a terminal of a positive polarity, and a terminal of a negative polarity. In some embodiments, the battery pack assembly may include additional features (e.g., cross members, a lid, a frame, or a base) that protect the battery pack assembly's internal components from external stressors (e.g., change in temperature, water, or contact with external forces). The battery pack assembly typically attaches to the base of an electric vehicle and delivers the electric vehicle DC power. In some embodiments, the internal components of the battery pack assembly may be accessed via the at least one auxiliary service panel to discharge the one or more battery modules. The battery pack assembly may include any suitable internal component (e.g., a flap blade connector, a data connector, a data cable, a bus, a busbar, or a contactor) to ensure the battery pack assembly functions properly.

As referred to herein, an “auxiliary service panel” is a panel configured to cover an opening in the lid of the battery pack assembly that allows for access to an unswitched terminal. It will be understood that the auxiliary service panel may be located at any suitable location on the lid of the battery pack assembly. In some embodiments, there may be any suitable number of auxiliary service panels on the lid of the battery pack assembly. The auxiliary service panel may be fastened shut via a sealing gasket, supported by bolts, surrounding the opening in the lid. In some embodiments, the auxiliary service panel is releasably attached to the lid of the battery pack assembly.

As referred to herein, an “unswitched terminal” is an unswitched supply of power delivered by the one or more battery modules. The unswitched terminal may be either of a positive or negative polarity depending on which pole of the one or more battery modules the terminal originates from.

As referred to herein, a “battery management system” is an internal component that monitors operational parameters such as voltage, current, and temperature signals from the battery pack assembly. In some embodiments, the battery management system monitors operational parameters in real time. In some embodiments, the battery management system uses isolated SPI communication protocol to receive the operational parameters (e.g., voltage, current, and temperature signals) from the battery pack assembly.

As referred to herein, a “flap blade connector” is a connector coupled to a busbar that allows access to the unswitched terminal. In some embodiments, an external device (e.g., a battery discharger) may couple to the flap blade connector to discharge the one or more battery modules in the battery pack assembly. It will be understood that there may be one or more flap blade connectors to correspond to the positive and negative poles of the one or more battery modules.

As referred to herein, a “battery module” is a battery cell, including a positive and a negative pole, that provides DC power to the battery pack assembly via a busbar.

As referred to herein, a “busbar” is a DC rail that couples to the positive and negative poles of the one or more battery modules and delivers DC power to the battery pack assembly.

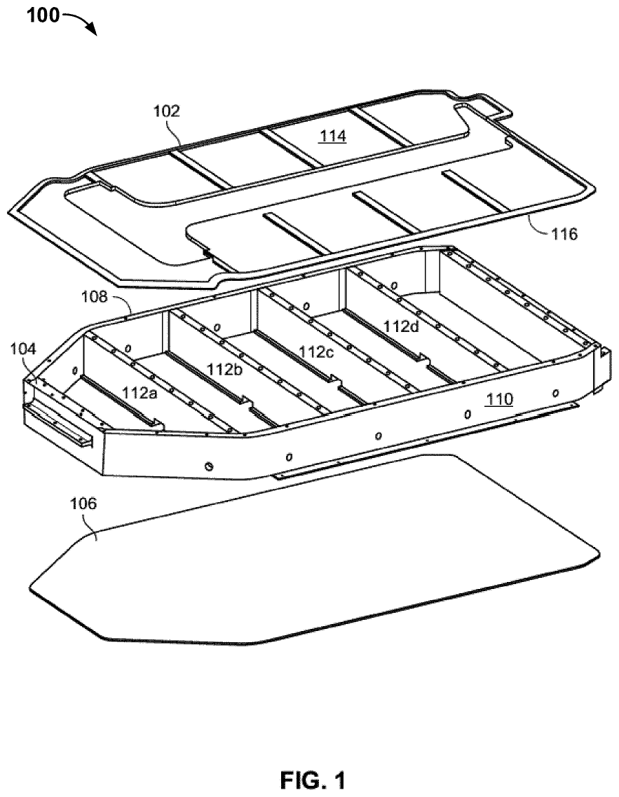

FIG. 1 shows an isometric exploded view of an exemplary battery pack assembly, in accordance with some embodiments of the present disclosure. A battery pack assembly 100 includes a lid 102, a base 106, and a frame 104, which includes side walls 108, 110 and cross members 112a-112d. The lid 102 comprises an upper surface 114 and a lower surface 116. The lid 102 and the base 106 are affixed to opposing sides (e.g., top and bottom surfaces) of the frame 104 to collectively define spaces within the frame 104 for receiving and protecting a plurality of battery cells and other electrical components that provide power for an electric vehicle. Upper surface 114 may have a number of reinforcing members and lower surface 116 may have a number of lateral support members for interfacing with the cross members 112a-112d.

Frame 104 may be constructed with opposing side walls 108, 110 that have a number of cross members 112a-112d extending therebetween for added strength and rigidity. Frame 104 may be made of any sufficiently rigid, strong, and non-flammable material, such as a metal (e.g., an extruded aluminum, a steel, etc.) or any composite material.

Lid 102 may be any generally flat structure that provides sufficient heat resistance, RF protection, and/or structural rigidity to support reinforcing members as further described below. In some embodiments, lid 102 may be constructed of a metal such as a stamped aluminum or steel sheet, a molded plastic, a composite material, or the like. Lid 102 may have the upper surface 114 that faces the underside of the occupant compartment of the vehicle within which battery pack assembly 100 is installed and the opposite lower surface 116 that faces the frame 104 and interior of the battery pack assembly 100.

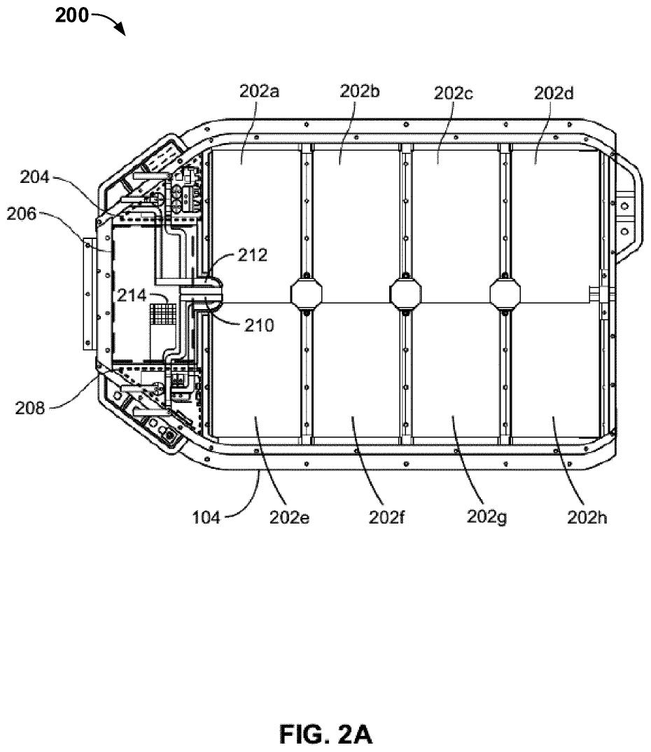

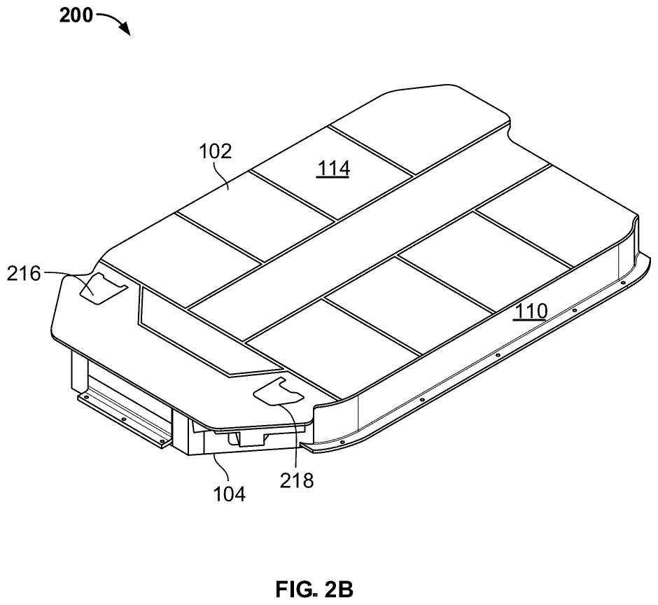

FIG. 2A shows an additional depiction of an exemplary battery pack assembly 200, in accordance with some embodiments of the present disclosure. Battery pack assembly 200 (which corresponds to battery pack assembly 100 in some embodiments) is depicted as having a plurality of battery modules (e.g., battery modules 202a-202h, which each comprise one or more battery cells), contactors, fuses 214, and busbars (e.g., first busbar 210 and second busbar 212). The battery modules 202a-202h are connected in series to form a high-power battery (e.g., having a voltage up to 400 V and capable of delivering high current). In some embodiments, the circuit and battery pack components (e.g., busbars, contactors, fuses, etc.) are located in triangular regions (e.g., regions 204 and 208). These triangular regions can be referred to, for example, as high voltage distribution boxes (HVDBs). HVDBs can provide power distribution, short circuit protection, access to the full voltage of the battery pack, and access to a battery management system or port. In some embodiments, a battery module 206 is included in the front bay of the battery pack assembly underneath the busbars. In some embodiments, battery module 206 corresponds to battery modules 202a-202h.

In some embodiments, battery pack assemblies 100 and 200 comprise a plurality of contactors, a plurality of busbars (e.g., first busbar 210 and second busbar 212), and a plurality of fuses 214. For example, the battery pack assembly may include at least one terminal contactor of a first polarity and at least one terminal contactor of a second polarity, each including an unswitched terminal and a switched terminal. The unswitched terminal of the first polarity contactor may be electrically coupled to a first polarity terminal of the battery modules 202a-202h, and the unswitched terminal of the second polarity contactor may be electrically coupled to a second polarity terminal of the battery modules 202a-202h. In some embodiments, at least one of the plurality of fuses 214 may be connected between the unswitched terminals of the contactors and the terminals of the battery modules 202a-202h. The at least one of the plurality of fuses 214 may comprise a first fuse terminal and a second fuse terminal. The first fuse terminal may be electrically coupled (e.g., via the first busbar 210) to the first polarity terminal of the battery modules 202a-202h. The second fuse terminal may be electrically coupled to the unswitched terminal of the second polarity contactor (e.g., via the second busbar 212).

In some embodiments, the first polarity terminal contactor and the second polarity terminal contactor and/or a first unswitched terminal and a second unswitched terminal of the battery modules 202a-202h are located at least a threshold distance from each other (e.g., 300 mm, 450 mm, 600 mm, 750 mm, 900 mm, 1050 mm, 1200 mm, 1350 mm, 1500 mm, 1650 mm, 1800 mm, etc.). Because of the physical separation between the first polarity and second polarity terminal contactors (and thereby the components electrically coupled to the first polarity terminal of the battery modules 202a-202h and the components electrically coupled to the second polarity terminal of the battery modules 202a-202h), the risk of a crash causing a short between the first polarity and second polarity unswitched terminals of the battery modules 202a-202h is minimized with respect to battery pack assemblies 100 and 200 having the first polarity and second polarity unswitched terminals in close proximity.

In the exemplary embodiment depicted in FIG. 2A, the first polarity terminal contactor is located in a first triangular region (e.g., region 208) and the second polarity terminal contactor is located in a second triangular region (e.g., region 204). In some embodiments, the first triangular region and the second triangular region are separated by the battery module 206. The triangular regions (e.g., regions 204 and 208) may not be perfect triangles and instead may be substantially triangle shaped. For example, the corners of the triangular region may be truncated resulting in a region that has six sides and is shaped as a triangle with truncated sides. In some embodiments, the regions for the circuit and battery pack components are chosen such that the components occupy space in the battery enclosure that cannot be occupied by a battery cell (e.g., due to the shape, size, orientation, etc., of the region or battery cell). In such embodiments, the shape and size of the regions may vary from that of a triangle and may be determined based on the size and shape of the battery pack components.

In some embodiments, the first polarity terminal of the battery modules 202a-202h may be electrically coupled to multiple parallel paths comprising a fuse in series with a contactor. For example, a first fuse and a first, first polarity terminal contactor may be electrically coupled in parallel to a second fuse and a second, first polarity terminal contactor.

For example, a first fuse terminal of the second fuse and the first fuse terminal of the first fuse may be electrically coupled in parallel with the unswitched first polarity terminal of the battery modules 202a-202h. The second fuse terminal of the second fuse may be electrically coupled to an unswitched terminal of a second, first polarity terminal contactor. A switched terminal of the second, first polarity terminal contactor may be coupled in parallel (e.g., via a busbar) to the switched terminal of the first, first polarity terminal contactor. In some embodiments, the dual fuse and dual contactor configuration discussed above may be arranged to fit within the triangle-shaped regions (e.g., regions 204 and 208) of battery pack assemblies 100 and 200. Although a dual fuse dual contactor arrangement is discussed above, additional contactors and fuses may be arranged without departing from the scope of the invention.

In some embodiments, the busbar electrically coupling the switched terminal of the first, first polarity terminal contactor and the switched terminal of the second, first polarity terminal contactor may additionally be electrically coupled to a load (e.g., a first polarity terminal of at least one electric motor of an electric vehicle) located external to the battery pack assembly. In some embodiments, the load substantially includes at least one motor of an electric vehicle. For example, at least half of the total current driven by battery modules 202a-202h may be directed to one or more electric motors of the electric vehicle.

FIG. 2B shows a perspective view of a battery pack assembly 200 including a lid with auxiliary service panels, in accordance with some embodiments of the present disclosure. Battery pack assembly 200 (which corresponds to battery pack assembly 100 in some embodiments) is depicted as having lid 102 affixed to the top of frame 104 with a first auxiliary service panel 218 and a second auxiliary service panel 216 positioned on lid 102. The auxiliary service panels are located above the first and the second triangular regions (e.g., regions 208 and 204) on lid 102, each providing access to interior battery pack components (e.g., busbars, fuses, contactors, connectors, etc. of HVDBs).

Frame 104 may be constructed with opposing side walls 108 (not visible), 110 that have a number of cross members 112a-112d (not visible) extending therebetween for added strength and rigidity. Frame 104 may be made of any sufficiently rigid, strong, and non-flammable material, such as a metal (e.g., an extruded aluminum, a steel, etc.) or any composite material.

Lid 102 may be any generally flat structure that provides sufficient heat resistance, RF protection, and/or structural rigidity to support reinforcing members. In some embodiments, lid 102 may be constructed of a metal such as a stamped aluminum or steel sheet, a molded plastic, a composite material, or the like. Lid 102 may have the upper surface 114 that faces the underside of the occupant compartment of the vehicle within which battery pack assembly 200 is installed and the opposite lower surface 116 (not visible) that faces the frame 104 and interior of the battery pack assembly 200.

The first auxiliary service panel 218 may be located on the left side of battery pack assembly 200 above the first triangular region (e.g., region 208) on lid 102. In some embodiments, the first auxiliary service panel 218 is positioned above a battery pack housing (e.g., a trapezoidal front bay located in front of battery modules 202a-202h). The first auxiliary service panel 218 provides access to a plurality of battery pack components, including an unswitched terminal of a first polarity, although it may be of any suitable polarity, a first flap blade connector, a battery management system, and a data connector. In some embodiments, the first auxiliary service panel 218 may provide access to any suitable battery pack component in battery pack assembly 200. The first auxiliary service panel 218 may be constructed of a metal such as a stamped aluminum, or steel sheet, a molded plastic, a composite material, or the like. In some embodiments, the first auxiliary service panel 218 is releasably attached to a first opening in the lid 102. One or more bolts fasten the first auxiliary service panel 218 to a first sealing gasket located between the first auxiliary service panel 218 and the lid 102. In some embodiments, an additional bolt may fasten the first auxiliary service panel 218 to the lid 102 for added security. The first auxiliary service panel 218 provides access to simultaneously discharge the battery modules 202a-202h, such as by allowing a robotic arm to simultaneously discharge the battery modules 202a-202h and monitor the battery pack components without removing the lid 102.

The second auxiliary service panel 216 may be located on the right side of battery pack assembly 200 above the second triangular region (e.g., region 204) on lid 102. A battery module (e.g., battery module 206) can be positioned between the first auxiliary service panel 218 and the second auxiliary service panel 216. In some embodiments, this arrangement causes the auxiliary service panels to be separated by a distance greater than the length of the battery module 206 (e.g., in the lateral direction of the battery pack assembly 200). In some embodiments, the second auxiliary service panel 216 is positioned above the battery pack housing (e.g., a trapezoidal front bay located in front of battery modules 202a-202h). The second auxiliary service panel 216 provides access to a plurality of battery pack components, include an unswitched terminal of a second polarity, although it may be of any suitable polarity, and a second flap blade connector. In some embodiments, the second auxiliary service panel 216 may provide access to any suitable battery pack component in battery pack assembly 200. The second auxiliary service panel 216 may be constructed of a metal such as a stamped aluminum, or steel sheet, a molded plastic, a composite material, or the like. In some embodiments, the second auxiliary service panel 216 is releasably attached to a second opening in the lid 102. One or more bolts fasten the second auxiliary service panel 216 to a second sealing gasket located between the second auxiliary service panel 216 and the lid 102. In some embodiments, an additional bolt may fasten the second auxiliary service panel 216 to the lid 102 for added security. The second auxiliary service panel 216 allows for simultaneously discharging the battery modules 202a-202h while monitoring the battery pack components without removing the lid 102.

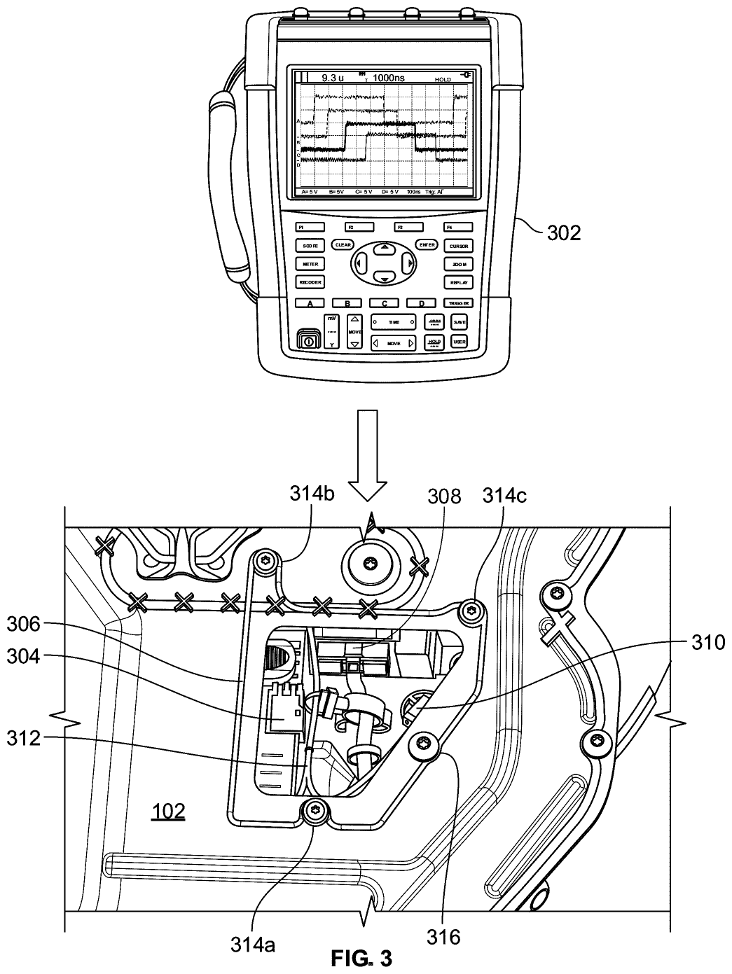

FIG. 3 shows an external monitoring device and a closeup view of a first opening in the battery pack assembly lid displaying various battery pack components, in accordance with some embodiments of the present disclosure. FIG. 3 depicts an external monitoring device 302 (e.g., for monitoring voltage, current, and/or temperature of components of the battery pack assembly), a first flip blade connector 304, a first sealing gasket 306, a battery management system 308, a data connector 310, a data cable 312, auxiliary service panel bolts 314a-314c, and a lid bolt 316. The first auxiliary service panel 218 covers the first opening depicted in FIG. 3, which may be located on the left side of battery pack assembly 200 above the first triangular region (e.g., region 208) on lid 102. In some embodiments, the first opening is positioned above the battery pack housing (e.g., a trapezoidal front bay located in front of battery modules 202a-202h).

The external monitoring device 302 can be coupled, through the first opening, to the data connector 310 via a monitoring cable of the external monitoring device 302, which allows for monitoring electrical signals (e.g., voltage, current, temperature, etc.) received at the external monitoring device 302 by the components of battery pack assembly 200 during discharging. The data connector 310 can be unplugged from battery pack assembly 200 and plugged into the external monitoring device 302 to monitor the electrical signals from battery pack components. In some embodiments, external monitoring device 302 may connect to battery management system 308 (e.g., using a data port thereof) via a monitoring cable to monitor electrical signals (e.g., voltage, current, temperature, etc.) of battery pack assembly 200. In some embodiments, the battery management system 308 may function properly, so the components of the battery pack assembly 200 may be monitored via the battery management system 308, or via the cable connected to the battery management system 308, instead. In some embodiments, the external monitoring device 302 may be incorporated in any figure shown in the present disclosure to monitor components of the battery pack assembly 200 during discharging or for evaluating the battery pack assembly. In some embodiments, any suitable monitoring device may be used.

The first flap blade connector 304, depicted with a blue tab cover, connects to a busbar (e.g., first busbar 210 or second busbar 212) via a bolt. The first flap blade connector 304 may include a tab that fits into a hole in the busbar to prevent rotation of the first flap blade connector 304 relative to the busbar. In some embodiments, the blue tab may be uncovered to reveal a first connector blade. An external device can be connected, via a first lead, to the first connector blade and, via a second lead, to a second connector blade of a second flap blade connector, accessible through a second opening above, for example, the second triangular region (e.g., region 204) on the right side of battery pack assembly 200. The external device can discharge the battery modules 202a-202h after coupling to the first flap blade connector 304 and the second flap blade connector. The external monitoring device 302 can monitor the components of the battery pack assembly 200 while discharging. In some embodiments, the flap blade connectors comprise access points to unswitched buses (e.g., busbars 210 and 212).

The first sealing gasket 306 is positioned between the first auxiliary service panel 218 and the lid 102 surrounding the first opening in the lid 102. In some embodiments, the first sealing gasket 306 is compressed by auxiliary service panel bolts 314a-314c acting on the first auxiliary service panel 218 to seal the first auxiliary service panel 218 against lid 102. Accordingly, the first sealing gasket 306 protects interior battery pack components from external environmental hazards. Under normal conditions, the battery management system 308 monitors electrical signals from a variety of battery components (e.g., battery modules 202a-202h, fuses 214, contactors, etc.) in the battery pack assembly 200.

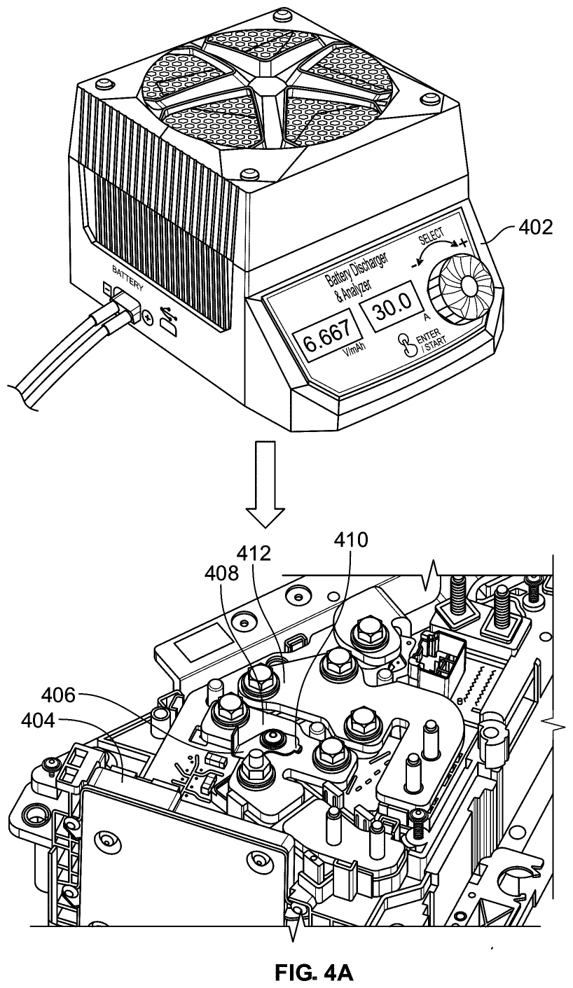

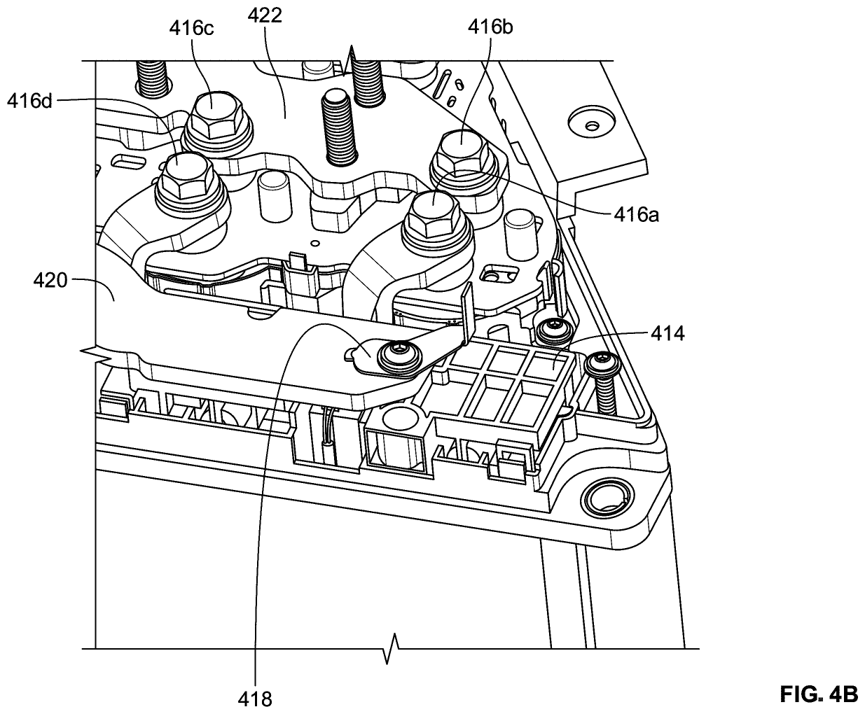

FIG. 4A shows an external device and a closeup view of battery pack assembly components on a first side (e.g., accessible via a first opening), in accordance with some embodiments of the present disclosure. FIG. 4A depicts an external device 402 (e.g., a battery discharger), a first flap blade connector 406 (corresponding to first flip blade connector 304), a battery management system 404 (corresponding to battery management system 308), a busbar 408, and a hole 410. The battery pack assembly components depicted in FIG. 4A are located in the first triangular region (e.g., region 208) of battery pack housing (e.g., a trapezoidal front bay located in front of battery modules 202a-202h).

The external device 402 (e.g., a battery discharger) couples, through the first opening, to the first flap blade connector 406 via a first lead of the external device 402 and couples, through a second opening, to a second flap blade connector via a second lead of the external device 402, which allows for discharging the battery modules 202a-202h of the battery pack assembly 200 while, in some embodiments, concurrently monitoring the components of the battery pack assembly 200 via the external monitoring device 302. In some embodiments, the external device 402 may be incorporated in any figure shown in the present disclosure to discharge battery modules 202a-202h of battery pack assembly 200. In some embodiments, any suitable battery discharger device may be used.

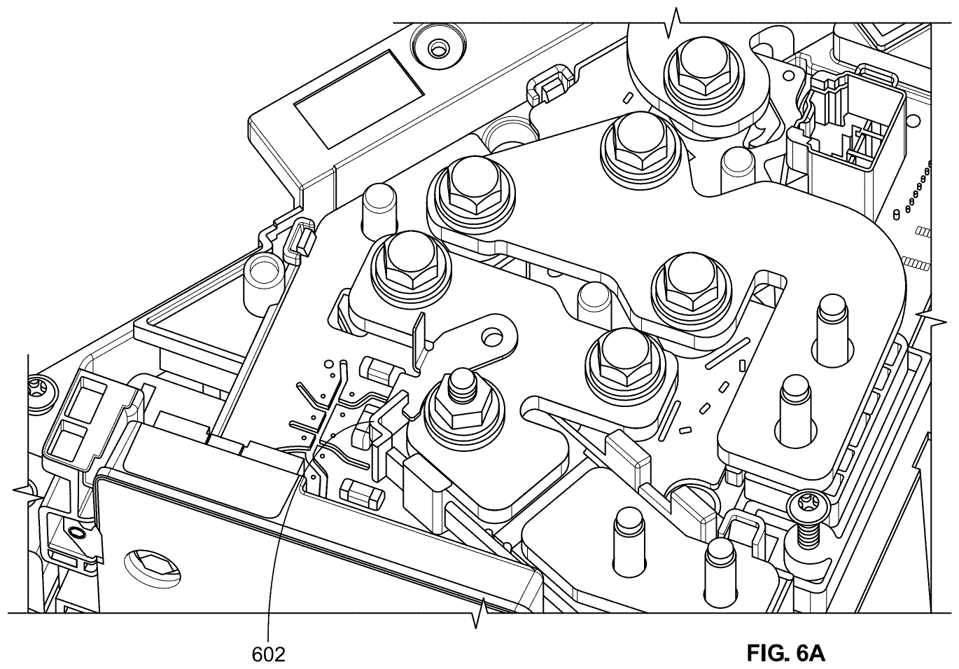

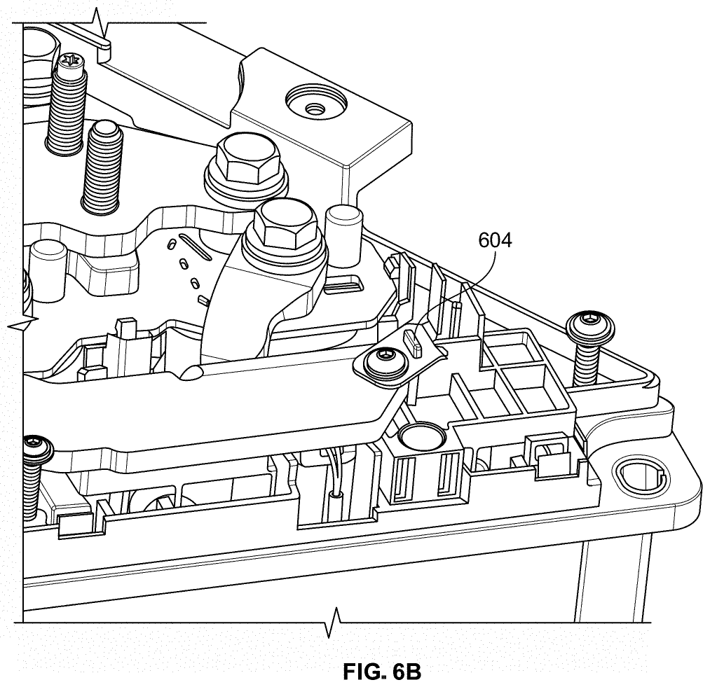

The first flap blade connector 406 connects to busbar 408 (e.g., first busbar 210 or second busbar 212) via a bolt. In some embodiments, the first flap blade connector 406, and the busbar 408, comprise an unswitched terminal of a first polarity (e.g., they are electrically coupled to the battery modules 202a-202h without any intervening contactors). In some embodiments, busbar 408 couples a variety of battery components to the unswitched terminal of either a first polarity or a second polarity. For example, two contactors can be electrically coupled in parallel between busbar 408 and busbar 412. In this arrangement, busbar 408 is an unswitched busbar and busbar 412 is a switched busbar, which can be used to power external components or devices. The first flap blade connector 406 includes a tab that fits into the hole 410 in busbar 408 to prevent rotation of the first flap blade connector 406 relative to the busbar 408. In some embodiments, an anti-rotation feature (e.g., hole 410) may be implemented in a variety of ways, as depicted in FIG. 6A and FIG. 6B of the present disclosure. In some embodiments, the external device 402 (e.g., a battery discharger) connects a first lead to the first flap blade connector 406 and a second lead to the second flap blade connector, accessible through the second opening above the second triangular region (e.g., region 204) on the right side of the battery pack assembly 200. The external device 402 discharges the battery modules 202a-202h after coupling to the first flap blade connector 406 and the second flap blade connector. The external monitoring device 302 can monitor the components of the battery pack assembly 200 while discharging. It will be understood that during normal conditions, the battery management system 404 monitors electrical signals (e.g., voltage, current, temperature, etc.) from a variety of battery components (e.g., battery modules 202a-202h, fuses 214, contactors, etc.) in the battery pack assembly 200.

FIG. 4B shows a closeup view of battery pack assembly components on a second side (e.g., accessible via a second opening), in accordance with some embodiments of the present disclosure. FIG. 4B includes busbar 420, which receives the second flap blade connector 418. Busbar 420 and second flap blade connector 418 may correspond to busbar 408 and flap blade connector 406 of FIG. 4A but are of an opposite polarity. In some embodiments, bolts 416a-416d couple busbar 420 to busbar 422 via two contactors (not visible). In this arrangement, busbar 420 is an unswitched busbar and busbar 422 is a switched busbar, which can be used together with busbar 414 to power external components or devices.

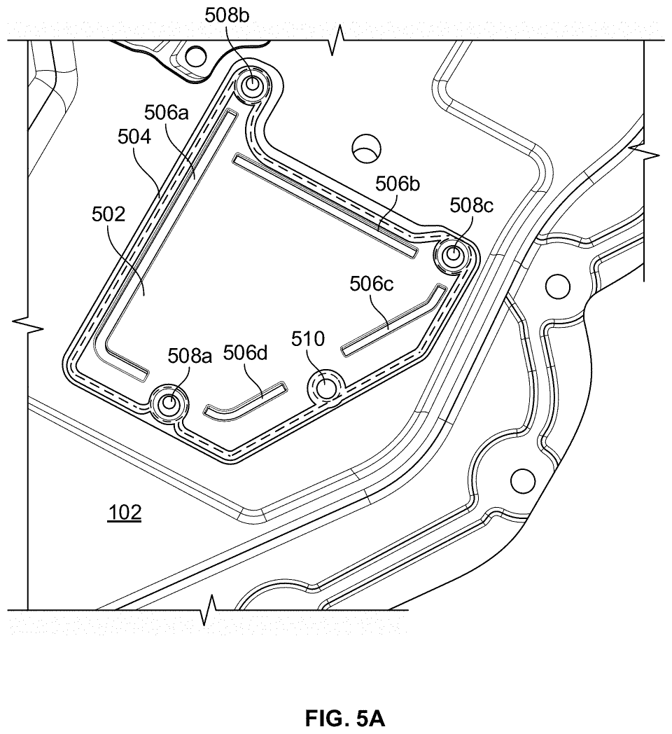

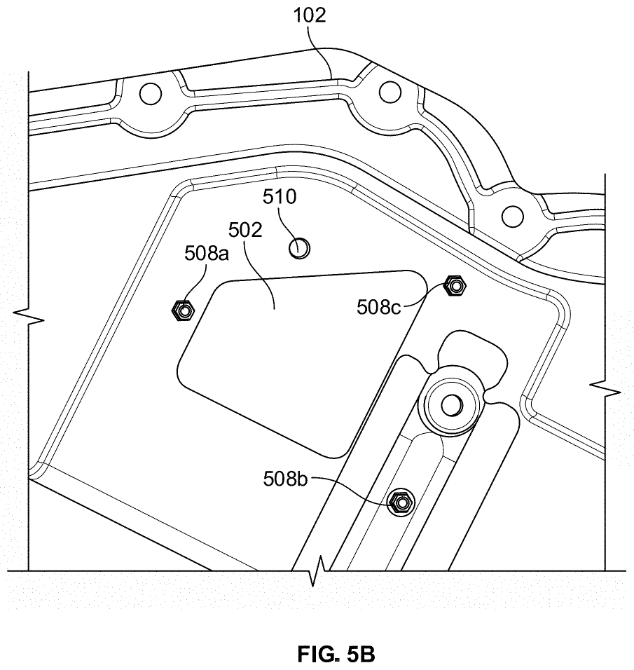

FIG. 5A shows a closeup view of an auxiliary service panel, in accordance with some embodiments of the present disclosure. FIG. 5A shows a first auxiliary service panel 502 (corresponding to first auxiliary service panel 218), a first sealing gasket 504 (corresponding to first sealing gasket 306), bends 506a-506d, auxiliary service panel bolts 508a-508c (corresponding to auxiliary service panel bolts 314a-314c), and a lid bolt hole 510. The battery pack assembly components depicted in FIG. 5A are located on the left side of battery pack assembly 200 above the first triangular region (e.g., region 208) on lid 102.

The first auxiliary service panel 502 may be located on the left side of battery pack assembly 200 above the first triangular region (e.g., region 208) on lid 102. In some embodiments, the first auxiliary service panel 502 is positioned above a battery pack housing (e.g., a trapezoidal front bay located in front of battery modules 202a-202h). The first auxiliary service panel 502 provides access to a plurality of battery pack components, including an unswitched terminal of a first polarity, although it may be of any suitable polarity, a first flap blade connector, a battery management system, and a data connector. In some embodiments, the first auxiliary service panel 502 may provide access to any suitable battery pack component in battery pack assembly 200. The first auxiliary service panel 502 may be constructed of a metal such as a stamped aluminum, or steel sheet, a molded plastic, a composite material, or the like. In some embodiments, the first auxiliary service panel 502 is releasably attached to a first opening in the lid 102. One or more bolts (e.g., auxiliary service panel bolts 508a-508c) fasten the first auxiliary service panel 502 to the lid 102, which compresses first sealing gasket 504. It will be understood that because sealing gasket 504 is positioned behind first auxiliary service panel 502, it is normally not visible in the view of FIG. 5A. It is only being shown in FIG. 5B for clarity so that its shape can be seen and understood. In some embodiments, the lid bolt 316, via the lid bolt hole 510, may fasten the first auxiliary service panel 502 to the lid 102 in addition to first sealing gasket 504 for added security. The first auxiliary service panel 502 allows for simultaneously discharging the battery modules 202a-202h while monitoring the battery pack components without removing the lid 102. In some embodiments, first auxiliary service panel 502 incorporates bends 506a-506d to strengthen the first auxiliary service panel 502. Any suitable bend design may be implemented on the first auxiliary service panel 502.

FIG. 5B shows a closeup bottom view of the first auxiliary service panel of FIG. 5A, in accordance with some embodiments of the present disclosure. FIG. 5B shows the bottom of first auxiliary service panel 502 visible through the first opening in lid 102, the bottom of auxiliary service panel bolts 508a-508c, and the lid bolt hole 510, all of which are described above.

It will be understood that the second auxiliary service panel (e.g., second auxiliary panel 216 shown in FIG. 2) may correspond to the first auxiliary service panel 502, but because it is positioned on a triangular region on the opposite side of the battery pack assembly, its shape may be a mirror image of first auxiliary service panel 502.

FIG. 6A shows a closeup view of an alternative design of battery pack assembly components, in accordance with some embodiments of the present disclosure. FIG. 6A includes an anti-rotation feature 602, which has a horizontal insert fit into the first flap blade connector 406 to prevent rotation of the first flap blade connector 406 relative to the busbar 408.

FIG. 6B shows a closeup view of an alternative design of battery pack assembly components, in accordance with some embodiments of the present disclosure. FIG. 6B includes an anti-rotation feature 604, which has a vertical insert fit into the second flap blade connector 418 to prevent rotation of the second flap blade connector 418 relative to the busbar 420.

In view of the foregoing, the auxiliary service panels of the present disclosure provide easy access for servicing, viewing, analyzing, or discharging of a battery pack. A first auxiliary panel can be adjusted to provide access to a first connector through a first opening of the battery pack. Similarly, a second auxiliary panel can be adjusted to provide access to a second connector through a second opening of the battery pack. In one example, the auxiliary panels are adjusted by removed screws and removing the auxiliary panels. In another example, the auxiliary panels are modified by removing one or more screws and rotating the auxiliary panels around a remaining screw to provide access to the openings. A first lead of an external device can be coupled to the first connector through the first opening. Similarly, a second lead of an external device can be coupled to the second connector through the second opening. For example, the two leads of the external device can be passed through respective openings and physically connected to respective connectors in the battery pack. The battery pack can then be discharged using the external device. In some embodiments, a data connector is also accessed through one of the openings and electrical signals therefrom can be monitored by an external monitoring device during discharging.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A battery pack assembly, comprising:
a first auxiliary service panel positioned to provide access to an unswitched terminal of a first polarity; and
a second auxiliary service panel positioned to provide access to an unswitched terminal of a second polarity.

2. The battery pack assembly of claim 1, wherein the first auxiliary service panel further provides access to a port of a battery management system and wherein the port of the battery management system comprises an access point to data of the battery pack assembly including voltage and temperature data.

3. The battery pack assembly of claim 1, wherein the access to the unswitched terminal of the first polarity comprises access to a first flap blade connector, wherein the access to the unswitched terminal of the second polarity comprises access to a second flap blade connector, and wherein at least one of the first flap blade connector and the second flap blade connector comprises an access point to an unswitched busbar configured to discharge the battery pack assembly.

4. The battery pack assembly of claim 1, further comprising a battery module positioned between the unswitched terminal of the first polarity and the unswitched terminal of the second polarity, wherein the first auxiliary service panel and the second auxiliary service panel are separated by a distance greater than a length of the battery module.

5. The battery pack assembly of claim 1, wherein the unswitched terminal of the first polarity comprises a flap blade connector attached to a busbar via a bolt.

6. The battery pack assembly of claim 5, wherein the busbar further comprises a hole and wherein the flap blade connector comprises a tab inserted in the hole to prevent rotation of the flap blade connector relative to the busbar.

7. The battery pack assembly of claim 1, further comprising a first contactor coupled to the unswitched terminal of the first polarity and a second contactor coupled to the unswitched terminal of the second polarity, wherein the first polarity is opposite the second polarity.

8. The battery pack assembly of claim 7, wherein the first contactor couples to the unswitched terminal of the first polarity via a first busbar and the second contactor couples to the unswitched terminal of the second polarity via a second busbar.

9. The battery pack assembly of claim 1, further comprising a lid that comprises a first opening and a second opening, wherein the first auxiliary service panel is releasably attached to the first opening and wherein the second auxiliary service panel is releasably attached to the second opening.

10. The battery pack assembly of claim 9, wherein the lid, the first auxiliary service panel, and the second auxiliary service panel are each made of a metal.

11. The battery pack assembly of claim 9, wherein the first auxiliary service panel and the second auxiliary service panel are each attached to the lid with one or more bolts.

12. The battery pack assembly of claim 9, further comprising:
a first sealing gasket positioned between the first auxiliary service panel and the lid surrounding the first opening in the lid; and
a second sealing gasket positioned between the second auxiliary service panel and the lid surrounding the second opening in the lid.

13. The battery pack assembly of claim 1, wherein the battery pack assembly is a battery pack for an electric vehicle and the battery pack further comprises:
a plurality of crossmembers that form a plurality of bays in the battery pack and the first and the second auxiliary service panels are positioned above a front bay of the plurality of bays.

14. The battery pack assembly of claim 13, wherein the first auxiliary service panel is on the left side of the battery pack and the second auxiliary service panel is on the right side of the battery pack.

15. A battery pack, comprising:
a battery pack housing comprising first and second openings;
at least one battery cell;
a first unswitched terminal of a first polarity electrically coupled to a first terminal of the at least one battery cell, wherein the first unswitched terminal is positioned under the first opening; and
a second unswitched terminal of a second polarity electrically coupled to a second terminal of the at least one battery cell, wherein the second unswitched terminal is positioned under the second opening.

16. The battery pack of claim 15, wherein the battery pack further comprises:
a first auxiliary service panel releasably attached to the battery pack housing to cover the first opening;
a second auxiliary service panel releasably attached to the battery pack housing to cover the second opening;
a battery module comprising one or more of the at least one battery cell;
first and second contactors; and
first and second busbars.

17. The battery pack of claim 15, wherein the first opening provides access to a port of a battery management system.

18. The battery pack of claim 15, wherein the first opening and the second opening are each in a lid of the battery pack housing.

19. A method of discharging a battery pack, comprising:
adjusting a first auxiliary service panel to access a first connector through a first opening;
adjusting a second auxiliary service panel to access a second connector through a second opening;
coupling, through the first opening, a first lead of an external device to the first connector;
coupling, through the second opening, a second lead of the external device to the second connector; and
discharging the battery pack using the external device.

20. The method of claim 19, further comprising:
accessing, through the first opening, a data connector; and
monitoring electrical signals received at an external monitoring device from the data connector during discharging.
